(19) United States
(12) Patent Application Publication
(10) Pub. No.: US 2005/0265308 A1
(43) Pub. Date: Dec. 1, 2005

(54) Selection techniques for logical grouping of VPN tunnels

(76) Inventors: Abdulkadev Barbir, Nepean (CA); Nalin Mistry, Nepean (CA); Wayne Ding, Kanata (CA)

Correspondence Address: SMART AND BIGGAR, 438 UNIVERSITY AVENUE, SUITE 1500 BOX 111, TORONTO, ON, M5G2K8, CA

(21) Appl. No.: 11/020,579

(22) Filed: Dec. 27, 2004

Related U.S. Application Data
(60) Provisional application No. 60/568,684, filed on May 7, 2004.

(51) Int. Cl. H04L 12/28

(52) U.S. Cl. 370/351

(57) ABSTRACT

At a service provider edge router in a service provider network, a logical grouping of one or more virtual private network tunnels through the service provider network is associated with a given value of a classification criterion. The receipt of a packet leads to a determination of a value of the classification criterion for the packet. Based on the value of the classification criterion, a logical grouping of one or more virtual private network tunnels may be selected and an identity of a processor, associated with the logical grouping determined. Finally, an internal route to the processor associated with the logical grouping is determined and the packet is sent over the internal route to the processor associated with the logical grouping.

### CROSS REFERENCE TO RELATED APPLICATIONS

The present application claims the benefit of prior application Ser. No. 60/568,684, filed May 7, 2004.

### FIELD OF THE INVENTION

The present invention relates to Virtual Private Networks (VPNs) and, more particularly, to the logical grouping of VPN tunnels. Further particularly, the present invention relates to methods and apparatus for distributing processing of incoming traffic to processors responsible for specific logical groupings of VPN tunnels.

### BACKGROUND

Traditionally, to securely connect geographically distributed private local area networks (LANs) of an enterprise to each other, telecommunication companies have leased out hard-wired connections, or at least an amount of guaranteed bandwidth on these connections. As well, to connect a single remote user to a private LAN, a remote user would dial in to a dedicated collection of modems, phone lines and associated network access servers. A private LAN is typically used for networking functions (e.g., e-mail, file sharing, printing) within an enterprise. Network connected devices within such a private LAN are not intended to be reachable by devices in other, unrelated networks. Increasingly, the use of Virtual Private Networks (VPNs) is replacing the use of leased hard-wired connections for providing links between LANs and the use of dedicated dial-up lines for providing remote users access to corporate intranets.

VPN technology enables secure, private connections between geographically remote sites over a shared “backbone” network. VPN technology may be used to implement a corporate intranet/extranet, to promote use of remote offices and/or to provide mobility to workers. Additionally, using VPN technology, services may be extended to multiple communities of interest.

At least three functional types of routers may be defined to comprise a VPN. customer edge (CE) routers sit at the customer site and are typically owned by the customer. However, some service providers provide equipment for CE routers. CE routers are connected to provider edge (PE) routers. PE routers are typically owned by service providers and serve as the entry points into the backbone network of the service provider. Finally, provider (P) routers are defined as transit routers within the backbone network. Physical links connect PE routers to P routers and P routers to other P routers.

To provide a VPN service to a customer, a service provider may set up one or more “tunnels” between a first PE router and a second PE router. Tunneling involves the encapsulation of a sender's data in packets, or, more generically in protocol data units. These encapsulated packets hide the underlying routing and switching infrastructure of the backbone network from both senders and receivers. At the same time, these encapsulated packets can be protected against snooping by outsiders through the use of encryption techniques. These tunnels may be made up of one or more physical links, yet, to the customer, it appears as though the first PE router is connected directly to the second PE router, i.e., the connection appears to be a single hop.

As service providers provide VPN services to an increasing number of customers, the associated VPN Routing and Forwarding Tables can become large and the distribution of these tables to particular nodes in the service provider's network may become unduly burdensome. Further, the application of the VPN Routing and Forwarding Tables can be processor intensive.

### SUMMARY

At a service provider edge router in a service provider network, a logical grouping of one or more virtual private network tunnels through the service provider network is associated with a given value of a classification criterion. The receipt of a packet leads to a determination of a value of the classification criterion for the packet. Based on the value of the classification criterion, a logical grouping of one or more virtual private network tunnels may be selected and an identity of a processor associated with the logical grouping determined. Finally, a route to the processor associated with the logical grouping is determined and the packet is sent over the route to the processor associated with the logical grouping.

In accordance with an aspect of the present invention there is provided a method of handing a protocol data unit at a service provider edge router in a service provider network. The method includes receiving a protocol data unit, determining a value of a classification criterion for the protocol data unit, selecting, based on the value of the classification criterion, a logical grouping of one or more virtual private network tunnels through the service provider network, determining an identity of a processor associated with the logical grouping, determining an internal route to the processor associated with the logical grouping and transmitting the protocol data unit, over the internal route, to the processor associated with the logical grouping. According to further embodiments of the invention, a provider edge router is provided for carrying out this method and a computer readable medium is provided to allow a processor to carry out this method.

In accordance with another aspect of the present invention there is provided a provider edge router in a service provider network, where virtual private network tunnels through the service provider network have been grouped in a plurality of logical groupings. The edge router includes a plurality of logical grouping processors, each logical grouping processor of the plurality of logical grouping processor associated with at least one logical grouping of the plurality of logical groupings and a plurality of virtual routers. Each virtual router of the plurality of virtual routers is operable to receive a protocol data unit, determine a value of a classification criterion for the protocol data unit, select, based on the value of the classification criterion, a candidate logical grouping from among the plurality of logical groupings, determine an identity of a candidate logical grouping processor, from among the plurality of logical grouping processors, where the candidate logical grouping processor is associated with the candidate logical grouping, determine an internal route to the candidate logical grouping processor and transmit the protocol data unit, over the internal route, to the candidate logical grouping processor.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 illustrates an exemplary network including a backbone network and several customer sites;

FIG. 2 illustrates the backbone network of FIG. 1 in greater detail;

FIG. 3 illustrates an exemplary VPN Routing and Forwarding Table;

FIG. 4 illustrates an exemplary IGP routing table;

FIG. 5 illustrates the backbone network of FIG. 2 with exemplary VPN tunnels identified;

FIG. 6 illustrates an exemplary logical group ID table according to an embodiment of the present invention;

FIG. 7 illustrates an exemplary VPN Routing and Forwarding Table and an exemplary IGP routing table, where the tables are associated with a first logical grouping of VPN tunnels according to an embodiment of the present invention;

FIG. 8 illustrates an exemplary sub-logical group ID table according to an embodiment of the present invention;

FIG. 9 illustrates an exemplary VPN Routing and Forwarding Table and an exemplary IGP routing table, where the tables are associated with a second logical grouping of VPN tunnels according to an embodiment of the present invention;

FIG. 10 illustrates an exemplary VPN Routing and Forwarding Table and an exemplary IGP routing table, where the tables are associated with a third logical grouping of VPN tunnels according to an embodiment of the present invention;

FIG. 11 illustrates an architecture for a provider edge router according to an embodiment of the present invention;

FIG. 12 illustrates a first exemplary path through the levels of a provider edge router according to an embodiment of the present invention;

FIG. 13 illustrates steps in a method of packet handling at a virtual router according to an embodiment of the present invention;

FIG. 14 illustrates steps in a method of packet handling at a logical group processor according to an embodiment of the present invention; and

FIG. 15 illustrates a second exemplary path through the levels of a provider edge router according to an embodiment of the present invention.

### DETAILED DESCRIPTION

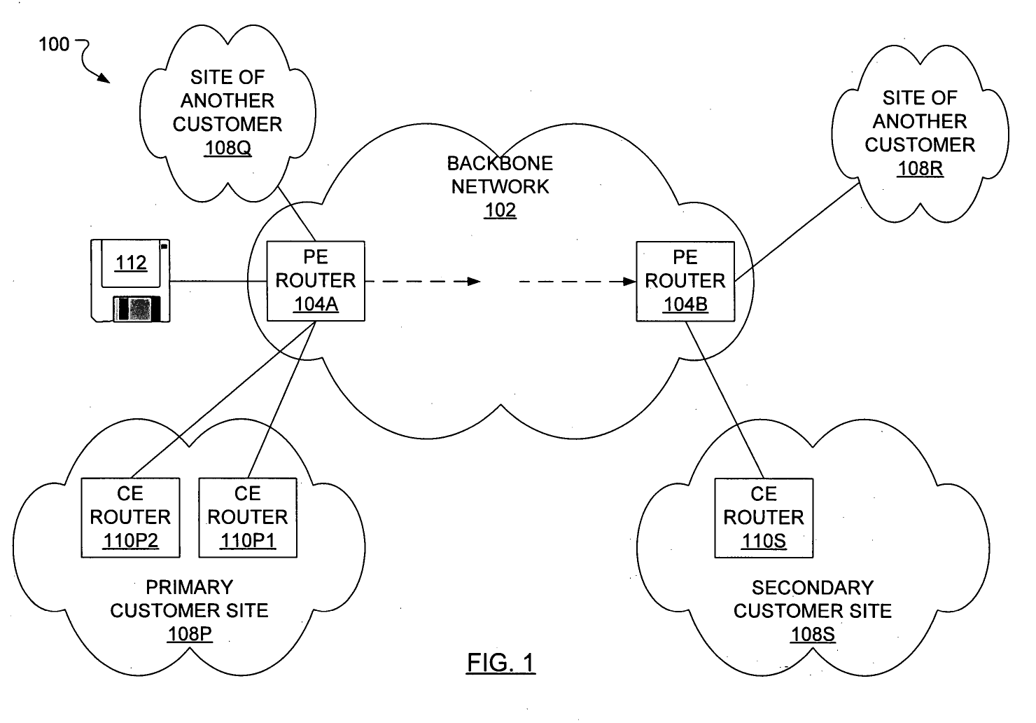

A simplified network 100 is illustrated in FIG. 1 wherein a backbone network 102 is used by a service provider to connect equipment at a primary customer site 108P to equipment at a secondary customer site 108S (collectively or individually 108). The backbone network 102 of the service provider may also be used to connect equipment at customer sites 108Q, 108R of other customers. A first CE router 110P1 and a second CE router 110P2 at the primary customer site 108P are connected to a first PE router 104A in the backbone network 102. Further, a third CE router 110S, at the secondary customer site 108S, is connected to a second PE router 104B in the backbone network 102. PE routers may be referred to individually or collectively as 104. Similarly, CE routers may be referred to individually or collectively as 110. The customer contracts with the service provider to provide one or more VPN tunnels between the first PE router 104A and the second PE router 104B. Each such tunnel may have particular Quality of Service (QoS) characteristics, such as speed of data transfer or delay.

The PE routers 104 may be loaded with logical grouping selection software for executing methods exemplary of this invention from a software medium 112 which could be a disk, a tape, a chip or a random access memory containing a file downloaded from a remote source.

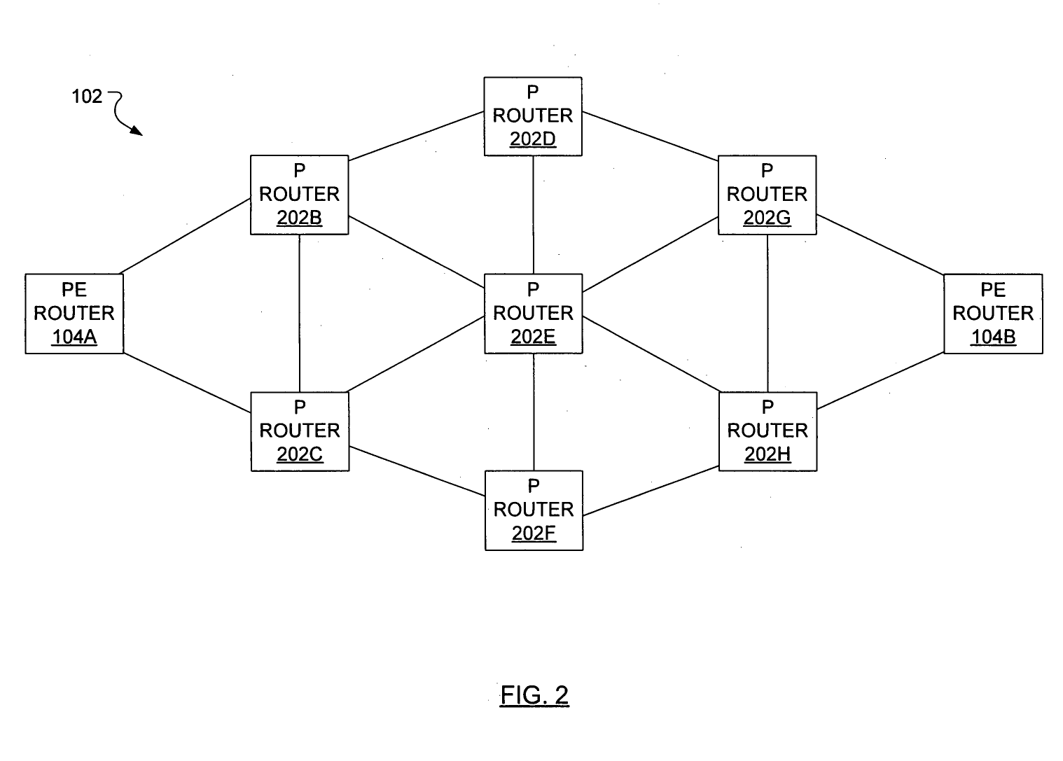

The content of the backbone network 102 of FIG. 1 is illustrated in further detail in FIG. 2. In particular, the backbone network 102 is illustrated to include a plurality of interconnected P routers 202B, 202C, 202D, 202E, 202F, 202G, 202H (individually or collectively 202). The P routers 202 are also interconnected with the PE routers 104. The links between the various routers 104, 202 may be electronic, optical or wireless. An optical link between routers may be, for example, an OC3 link employing the known SONET (Synchronous Optical NETwork) standard. Note-that the P routers 202 may connect to neighboring routers 104, 202 using more than one physical link and that the links are understood to be made up of two unidirectional links carrying traffic in opposite directions.

Protocols that have been defined and have been useful in the development of VPNs include the known Border Gateway Protocol (BGP), the Interior Gateway Protocol (IGP) and Multi Protocol Label Switching (MPLS).

A particular implementation of VPNs is described in E. Rosen, et al., “BGP/MPLS VPNs”, Internet Engineering Task Force (IETF) Request for Comments (RFC) 2547, available at www.ietf.org and hereby incorporated herein by reference, which specifies using a peer-to-peer model, in which routing information is exchanged using BGP: between a CE router 110 and a PE router 104; from one PE router 104 to another PE router 104 within the network of a single service provider; or between P routers 202.

In BGP/MPLS based VPNs, the service provider is responsible for establishing paths through a backbone network and propagating routing information to customer sites. Security and privacy is achieved by limiting the distribution of the routing information specific to a given VPN only to members of the given VPN. That is, information about routes to VPN sites is only advertised to members of the given VPN and is not shared with devices outside the given VPN.

MPLS is based upon routers, or switches, performing label switching to provide a Label Switched Path (LSP) through a network. In simple terms, when an IP packet enters an interface of an MPLS ingress router, that router assigns the packet to a Forwarding Equivalency Class (FEC).

The labels used in MPLS have only local significance. Intervening Label Switch Routers (LSRs, i.e., the P routers 202) “swap” the label on an incoming packet for a label defined in the MPLS forwarding database particular to the LSR. When the MPLS egress, or final, router is reached, the label is permanently removed, or “popped”, prior to the egress router forwarding the regular IP packet.

MPLS may be used to forward packets over a network backbone and BGP may be used to distribute routing information. Routing information may be passed between a CE router 110 and the PE router 104, to which the CE router 110 is directly connected, using IGP, BGP or through default routes defined on each router in the VPN. Each PE router 104 may maintain one or more per-site forwarding tables known as VPN Routing and Forwarding Tables (VRFs). Within a given PE router 104, each VRF serves a particular interface, or set of interfaces, that belong to each individual VPN. That is, for each VPN to which a given PE router 104 belongs, the PE router 104 has a corresponding VRF.

In order to support overlapping address spaces, BGP/MPLS based VPNs utilize the VPN-IPv4 (VPN-Internet Protocol version 4) address family combined with multi-protocol extensions to BGP. A VPN-IPv4 address is a 12 byte address that begins with eight byte Route Distinguisher (RD) and ends with a four byte IPv4 address. It is the task of PE routers 104 to translate IPv4 addresses into unique VPN-IPv4 addresses. This ensures that if a given IPv4 address is used in two different VPNs, it is possible that two different routes to the given IPv4 address may be stored in appropriate VPN Routing and Forwarding Tables, one route for each VPN.

There are two control mechanisms within BGP/MPLS VPNs. The first control mechanism is used for the exchange of routing information between different PE routers that make up a VPN. The second control mechanism is used for the establishment of LSPs across a service provider backbone network.

In the first control mechanism, the PE routers 104 learn customer routes from CE routers 110. These routes may be learned through the use of an IGP, BGP or through static configuration on the PE router 104.

In the second control mechanism, LSP establishment for VPN tunnels may be accomplished through the known Label Distribution Protocol (LDP) or Resource reSerVation Protocol (RSVP), for instance. A service provider would use LDP when there is a need to establish best effort routing between PE routers 104 using a particular IGP. However, if there is a need for the service provider to assign bandwidth requirements, other constraints, or offer advanced services, RSVP may be seen as a better choice to signal the LSP path.

The following description of a method of forwarding packets across the backbone is adapted from RFC 2547, which was incorporated by reference hereinbefore.

Even though the intermediate P routers 202 in the backbone 102 do not have any information about routes associated with the VPNs, packets are forwarded from one VPN site (customer site 108) to another using MPLS with a two-level label stack.

The PE routers 104 may insert address prefixes for themselves into the IGP routing tables of the P routers 202 of the backbone network 102. These address prefixes enable the MPLS process at each P router 202 to assign a label corresponding to the route to each PE router 104. Notably, certain procedures for setting up label switched paths in the backbone network 102 may not require the presence of these address prefixes.

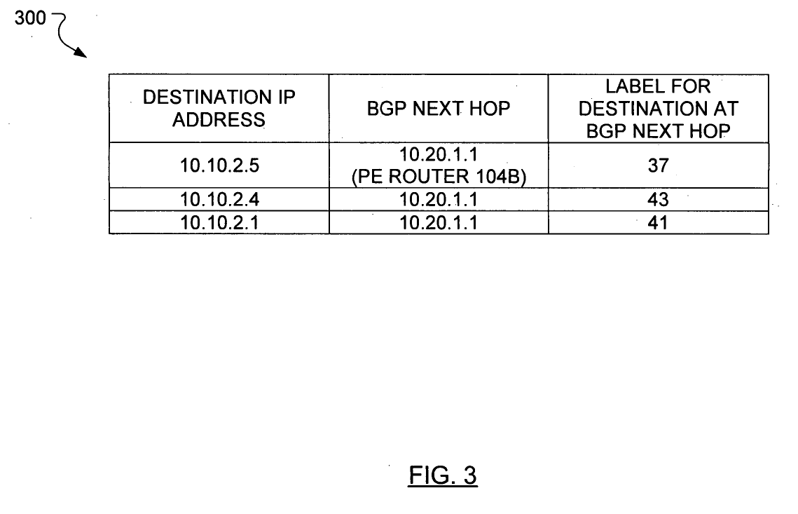

Consider a scenario wherein the first PE router 104A receives a protocol data unit, say, an IP packet from the first CE device 110P1 in the primary customer site 108P. The IP packet is understood to include a standard IP header as well as payload. Such an IP header typically includes such information as a source IP address and a destination IP address. The first PE router 104A initially selects a VRF particular to the VPN (typically identified in the packet by a VPN ID) and uses the destination address of the packet as a lookup key for the VRF. FIG. 3 illustrates an exemplary VRF 300. Put another way, the first PE router 104A identifies a classification criteria of the received packet, where, in this case, the classification criteria is the VPN identified by the VPN ID in the packet.

If the packet is destined for the second CE router 110P2 in the primary customer site 108P attached to the first PE router 104A, the packet is sent directly to the second CE router 110P2.

If the packet is not destined for a CE device attached to the first PE router 104A, a “BGP next hop” (i.e., the appropriate PE router 104 attached to the destination CE device, e.g., the second PE router 104B) for the packet is found in the VRF, as well as the label that has been assigned, at the BGP next hop, to the destination address of the packet. In the exemplary VRF 300 (FIG. 3), the destination IP address 10.10.2.5 may be used as a lookup key to determine a BGP next hop (it is assumed that the IP address of the second PE router 104B is 10.20.1.1) and a label (37) assigned at the BGP next hop to the destination IP address 10.10.2.5. (Note that, despite the fact that we are using IP-style addresses in this example, the present invention is not limited to an IP implementation.)

It may be considered that the use of a VRF constitutes the performance of a selection algorithm, where the result of the performance of the selection algorithm is information to be used when forwarding the packet. The information that may be learned from the exemplary VRF 300 and used when forwarding the packet includes an address for the destination PE router 104 and a label to identify the destination CE router 110 to the destination PE router 104.

Consider, for instance, that the packet is destined for the third CE router 110S attached to the second PE router 104B.

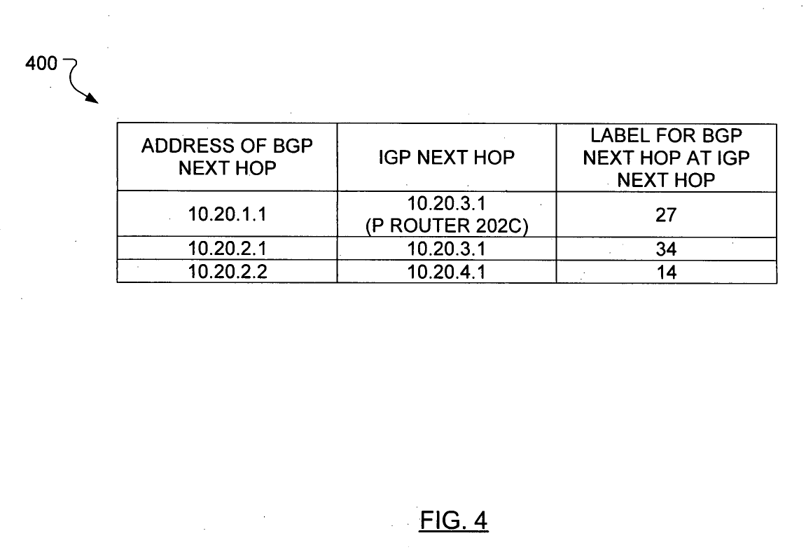

The label associated with the destination of the packet (the third CE router 110S) by the BGP next hop (the second PE router 104B) is pushed onto the MPLS label stack of the packet, by the first PE router 104A, and becomes the bottom label. The first PE router 104A then uses the BGP next hop as a key to lookup, in an IGP routing table 400 (FIG. 4), an IGP route to the BGP next hop. The IGP allows navigation through the network 102 to the boundary PE attached to the destination CE. The IGP routing table 400 provides the first PE router 104A with an identity for an IGP next hop (e.g., the P router 202C). From the same table, the first PE router 104A learns the label assigned to the address of the BGP next hop (the second PE router 104B) by the IGP next hop (the P router 202C) according to a given label switched path. This label gets pushed onto the MPLS label stack of the packet, and becomes the top label, and the packet is then forwarded to the IGP next hop. In a special case, the BGP next hop is the same as the IGP next hop, and the label assigned to the address of the BGP next hop may not need to be pushed onto the MPLS label stack of the packet.

At this point, the P routers 202 use MPLS to carry the packet across the backbone network 102 and to the third CE router 110S. That is, all forwarding decisions by P routers 202 and PE routers 104 are now made by an MPLS process. To continue the example, the P router 202C reads the top label of the MPLS stack and, from a forwarding table, the P router 202C determines the IGP next hop—i.e., the next P router to which to forward the packet—(say, the P router 202E) and learns the label associated with that destination. This label gets pushed onto the MPLS label stack of the packet, and becomes the top label, and the packet is then forwarded to the IGP next hop. The label stack associated with the IP packet is distinct from the IP header. The IP header of the packet is not looked at again until the packet reaches the third CE router 110S. Upon receiving the packet, the second PE router 104B “pops” the bottom label out of the MPLS label stack of the packet before sending the packet to the third CE router 110S, thus the third CE router 110S simply sees an ordinary IP packet.

In review, in the known BGP/MPLS based implementation of VPNs, when a packet identifying a particular VPN enters the backbone network 102 at a given PE router, the route of the packet through the backbone network 102 is determined by the contents of the forwarding table that the given PE router has associated with the particular VPN. The forwarding tables of the PE router 104 where the packet leaves the backbone network 102 are not used.

Note that it is the two-level labeling that makes it possible to keep all the VPN routing information out of the P routers 202 and this two-level labeling, in turn, assists to ensure the scalability of the model. The P routers 202 of the backbone network 102 need not maintain information on routes to the CE routers 110, the P routers 202 need only maintain information on routes to the PE routers 104.

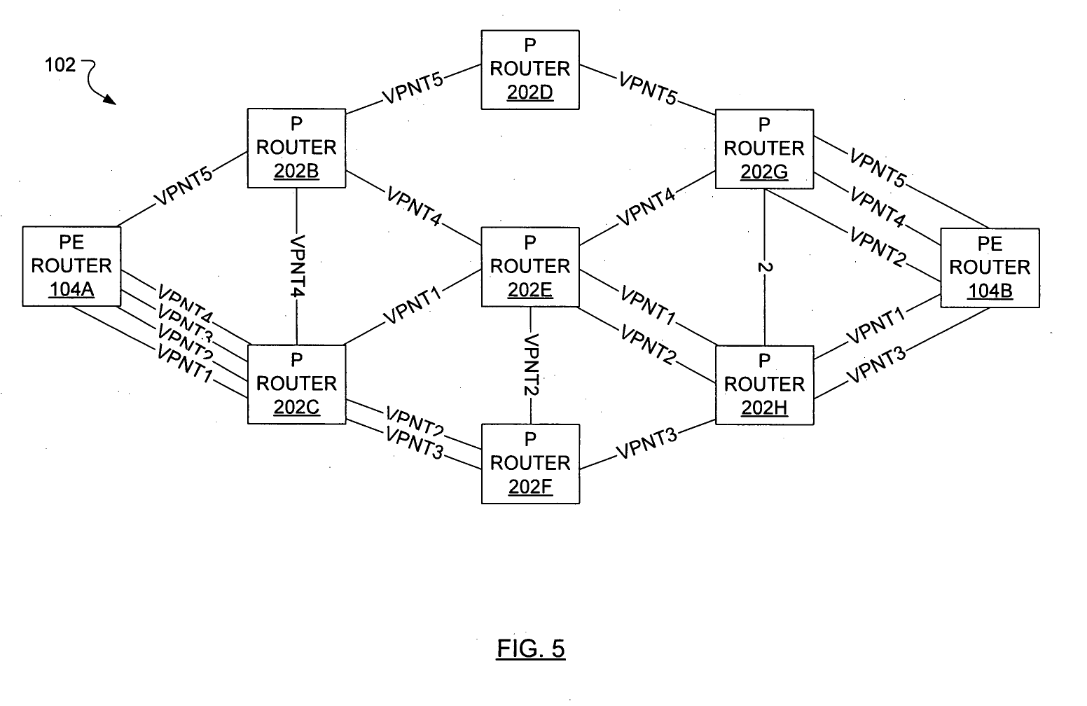

Notably, a given routing table may not associate only a single IGP route to a given BGP next hop. There may, in fact, be multiple label switched paths (LSPs) between the PE router 104 of interest and the given BGP next hop. Each of these LSPs may be considered, in the context of BGP/MPLS based VPNs, to be a VPN tunnel. The detail of the backbone network 102, first illustrated in FIG. 2, is illustrated again in FIG. 5, showing five LSPs, or VPN tunnels, from the first PE router 104A to the second PE router 104B.

In particular, the five VPN tunnels include: a VPN tunnel identified as VPNT1 that passes through the P routers C, E and H; a VPN tunnel identified as VPNT2 that passes through the P routers C, F, E and H; a VPN tunnel identified as VPNT3 that passes through the P routers C, F and H; a VPN tunnel identified as VPNT4 that passes through the P routers C, B, E and G; and a VPN tunnel identified as VPNT5 that passes through the P routers B, D and G. It may be advantageous to consider the VPN tunnels that have common characteristics to be logically grouped. For instance, one logical grouping (logical group ID=700) may include VPNT1, VPNT3 and VPNT5 because these VPN tunnels each have only four hops. Another logical grouping (logical group ID=800) may include all five VPN tunnels and be based, on available bandwidth.

Returning to the example described above, it may be recognized that the label switched path taken by the packet corresponds to the VPN tunnel identified as VPNT1. By selecting a particular label for the BGP next hop (the second PE router 104B), the first PE router 104A selects the VPN tunnel identified as VPNT1. As indicated in the VRF 300 (FIG. 3), other labels are associated with the same BGP next hop. By selecting another label, another label switched path, and thus another VPN tunnel, is selected.

In overview, based on classification criteria identified in a packet received from the first CE router 110P1, the first PE router 104A may select a logical grouping of VPN tunnels, rather than selecting a single VPN tunnel through which to forward a packet. Further sub-groupings of the selected logical grouping of VPN tunnels may be selected based on further packet characteristics. Eventually, a single VPN tunnel through which to forward a packet may be selected, and the packet may then be forwarded in a traditional manner. As will be apparent upon review of the following, the classification criteria may be widely varied, rather than being limited to a VPN-specific model. With reference to the commonly-referenced multi-layered communication model, Open Systems Interconnection (OSI), the classification criteria may include: layer 1 criteria, for instance, input port; layer 2 criteria, for instance, a VPN group identifier; layer 3 criteria, for instance, source Internet protocol (IP) address and/or destination IP address; and layer 7 criteria, for instance, an indication that the packet is carrying Hypertext Transport Protocol (HTTP) traffic.

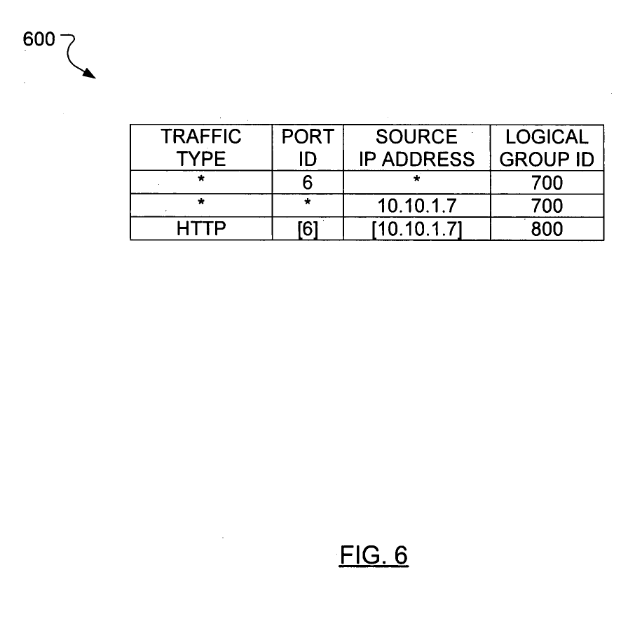

The initial table lookup performed by the first PE router 104A then, upon receipt of a packet, may be in a table such as a logical group ID table 600 illustrated in FIG. 6. The logical group ID table 600 associates classification criteria of the received packet with a logical grouping of VPN tunnels. A VRF (VPN Routing and Forwarding Table) may then be associated with each logical grouping. Optionally, a sub-logical group ID table may allow further differentiation of packets based on further classification criteria.

The classification criteria associated in the logical group ID table 600 with various logical groupings of VPN tunnels includes an indication of traffic type, an identifier of the interface (i.e., the port) on which a given packet is received and the source IP address of the packet. In particular, those packets received on port 6 or having a source IP address of 10.10.1.7 are associated with the logical grouping that has a logical group ID of 700. Recall that VPNT1, VPNT3 and VPNT5 make up the logical grouping with the logical group ID of 700 because these VPN tunnels each have only four hops. It may be that the customer prefers traffic from the identified port or source IP address to use minimum-hop-count VPN tunnels.

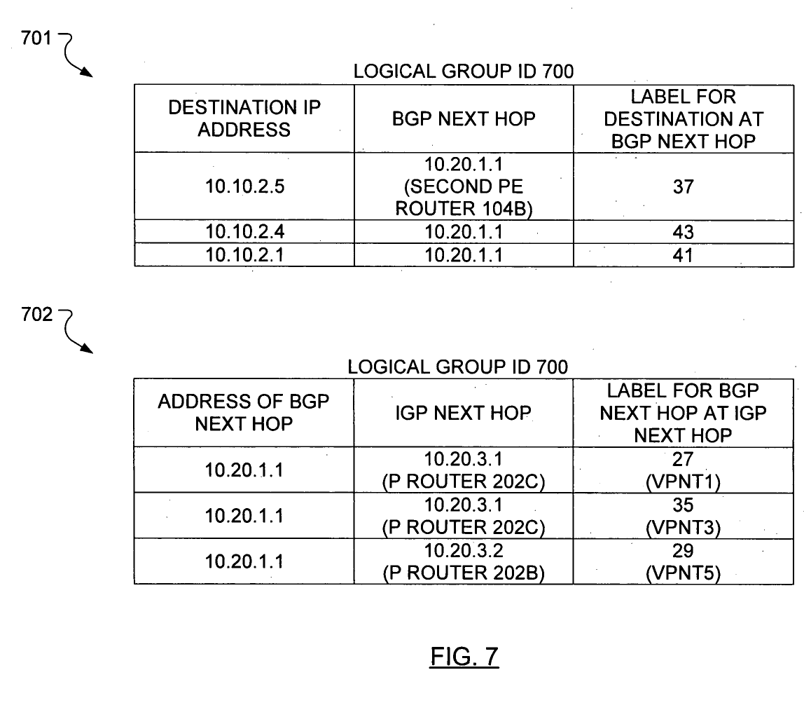

If, for example, the request for minimum-hop-count tunnels is the only restriction placed on this traffic, the first PE router 104A, upon receiving a packet having these characteristics may be directed by the logical group ID table 600 to a VRF 701 (FIG. 7) associated with the logical grouping of VPNs that has the logical group ID of 700. The logical group 700 VRF 701 associates a destination IP address with a label that may be used by the BGP next hop (i.e., at the second PE router 104B) to identify a network element having the destination IP address.

The first PE router 104A then uses the BGP next hop as a key to lookup, in a logical group 700 IGP routing table 702, an IGP route to the BGP next hop. The logical group 700 IGP routing table 702 provides the first PE router 104A with an identity for an IGP next hop. From the same table, the first PE router 104A learns the label assigned to the address of the BGP next hop (the second PE router 104B) by the IGP next hop according to an associated label switched path. As shown in FIG. 7, the logical group 700 IGP routing table 702 provides two choices of IGP next hop and, overall, three choices of label for the BGP next hop at the IGP next hop. Each of the three label choices corresponds to one of the three VPN tunnels that make up the logical group 700.

The VPN tunnel selected from the three choices may be selected according to some traffic balancing algorithm. For instance, each packet to be sent over the logical group 700 VPN tunnels may be sent over a different tunnel in a rotating format (VPNT1, VPNT3, VPNT5, VPNT1, . . . , etc.). Alternatively, all packets identified as being part of a particular flow may use the same VPN tunnel and the rotating use of these three VPN tunnels may rotate with each new flow. Such balancing algorithms may be chosen to provide a particular degree of traffic distribution between the three VPN tunnels in the logical grouping.

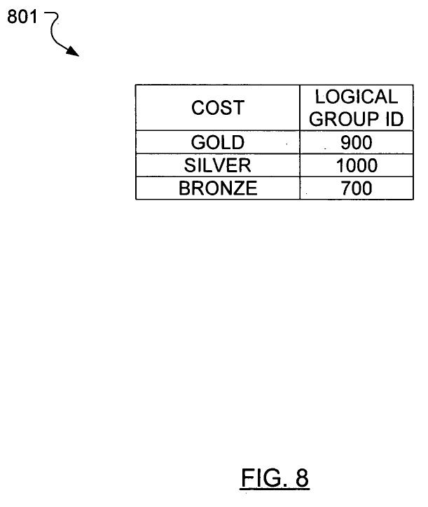

Returning to the logical group ID table 600 of FIG. 6, it may be seen that those packets, received whose traffic type is HTTP are associated with the logical grouping that has a logical group ID of 800. Recall that all five VPN tunnels make up the logical grouping with the logical group ID of 800 because each of the VPN tunnels meets a minimum bandwidth criterion. However, there may be further criteria against which the packets may be judged. As such, the first PE router 104A, upon receiving a packet having these characteristics may be directed by the logical group ID table 600 to a sub-logical group ID table 801 (FIG. 8) by virtue of an association of the logical group ID of 800 with table 801.

The sub-logical group ID table 801 associates a classification criteria of “cost” with a logical group ID. Each of the links that make up a label switched path over which a VPN tunnel may be defined has an associated cost to the service provider and, perhaps corresponding to the cost will be other characteristics such as delay. A customer of the service provider may be willing to pay a premium for certain traffic to be carried on the higher cost VPN tunnels. In such a case, the customer may mark packets with an indication of the level of cost that may be borne in the transfer of the marked packet. These levels may be, for instance, gold, silver and bronze.

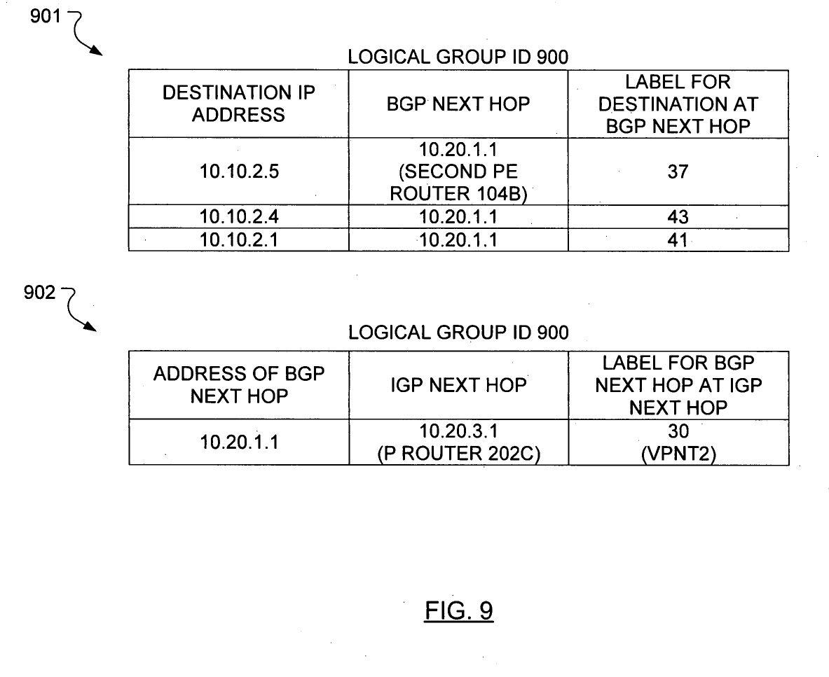

In FIG. 8, it may be seen that gold traffic is to be associated with the logical grouping that has the logical group ID of 900. The first PE router 104A, upon receiving a packet marked as gold may be directed by the sub-logical group ID table 800 to a VRF 901 (FIG. 9) associated with the logical grouping that has the logical group ID of 900. The logical group 900 VRF 901 associates destination IP addresses with labels that are used by the BGP next hop (i.e., at the second PE router 104B) to identify the same network elements.

The first PE router 104A then uses the BGP next hop as a key to lookup, in a logical group 900 IGP routing table 902, an IGP route to the BGP next hop. The logical group 900 IGP routing table 902 provides the first PE router 104A with an identity for an IGP next hop. From the same table, the first PE router 104A learns the label assigned to the address of the BGP next hop (the second PE router 104B) by the IGP next hop according to an associated label switched path. As shown in FIG. 9, the logical group 900 IGP routing table 902 provides only one choice of IGP next hop. The single choice corresponds to the VPN tunnel VPNT2.

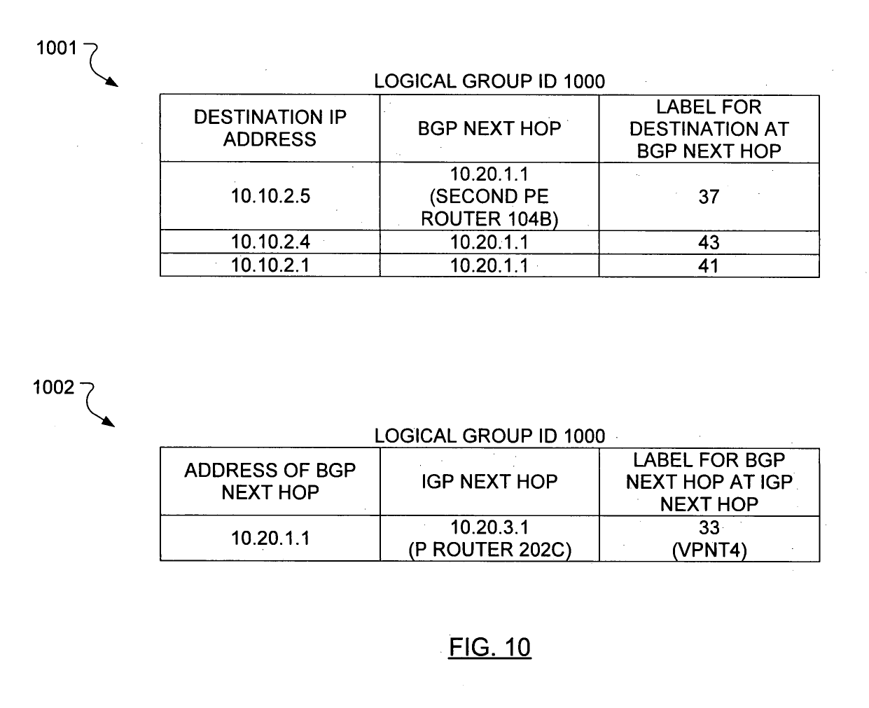

Returning to FIG. 8, it may be seen that silver traffic is to be associated with the logical grouping that has the logical group ID of 1000. The first PE router 104A, upon receiving a packet marked as silver may be directed by the sub-logical group ID table 800 to a VRF 1001 (FIG. 10) associated with the logical grouping that has the logical group ID of 1000. The logical group 1000 VRF 1001 associates destination IP addresses with labels that are used by the BGP next hop (i.e., at the second PE router 104B) to identify the same network elements.

The first PE router 104A then uses the BGP next hop as a key to lookup, in a logical group 1000 IGP routing table 1002, an IGP route to the BGP next hop. The logical group 1000 IGP routing table 1002 provides the first PE router 104A with an identity for an IGP next hop. From the same table, the first PE router 104A learns the label assigned to the address of the BGP next hop (the second PE router 104B) by the IGP next hop according to an associated label switched path. As shown in FIG. 10, the logical group 1000 IGP routing table 1002 provides only one choice of IGP next hop. The single choice corresponds to the VPN tunnel VPNT4.

Returning to FIG. 8 once more, it may be seen that bronze traffic is to be associated with the logical grouping that has the logical group ID of 700. The first PE router 104A, upon receiving a packet marked as bronze may be directed by the sub-logical group ID table 800 to the logical group 700 VRF 701 that has been discussed hereinbefore and a VPN may be selected based on load balancing.

The use of the logical groupings of VPN tunnels may not be limited to merely inspecting packet contents. Once a packet is identified as having a given classification criterion, the packet may be modified. Wired Ethernet includes support for Quality of Service (QoS) in the form of 802.1p packet tagging based on the IEEE 802.1D specification, which defines the addition of four bytes to the legacy Ethernet frame format. The defined priority tagging mechanism is known as IEEE 802.1p priority tagging, and it allows for eight levels of priority.

It may be then, that traffic units arrive at a PE router 104 with eight levels of priority. It may also be that the traffic units depart the PE router 104 with eight levels of priority. However, the levels may not map directly. For instance, if three of eight levels of priority at the output of the PE router 104 are reserved for some reason, the eight levels of priority of the incoming traffic units must be mapped to the remaining five levels of priority available in the PE router 104. By appropriately configuring the logical groupings, a mapping to a particular one of the available levels of priority may be targeted to incoming packets having, for instance, one of two levels of priority.

Packet modification may also be extended to include packet encapsulation. For instance, a customer may require an additional level of security for packets originating at a specific address. An appropriately configured logical group ID table may select packets from that specific address for security encapsulation.

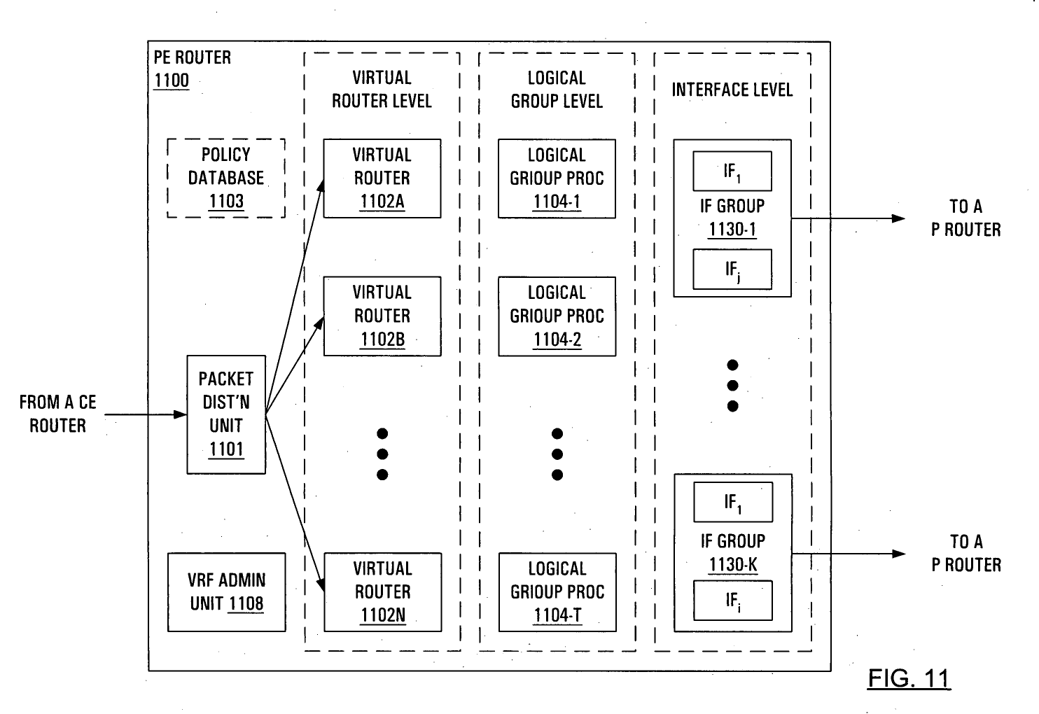

In the discussion hereinbefore, the logical group ID table 600 of FIG. 6 is used to associate classification criteria of a received packet with a logical grouping of VPN tunnels. Additionally, a VRF (VPN Routing and Forwarding Table) is associated with each logical grouping. Once classification criteria of the received packet are associated with the logical grouping, the received packet is processed based on the VRF associated with the logical grouping. An architecture through which the application of the VRF to the received packet may be undertaken is illustrated in FIG. 11.

In particular, a PE router 1100 is illustrated to include a multiple processing levels through which a received packet is to pass. A virtual router level includes a plurality of virtual routers 1102A, 1102B, . . . , 1102N (collectively or individually 1102) that receive incoming packets from a packet distribution unit 1101. A logical group level includes a plurality of logical group processors 1104-1, 1104-2, . . . , 1104T (collectively or individually 1104) selectively connected to the virtual routers 1102. The packets output from the logical group processors 1104 are subsequently output to PE routers, in a network exemplified by the backbone network 102 illustrated in FIG. 2, via an interface level that includes groupings of interfaces (IF₁, . . . , IFⱼ), where the groupings of interfaces are called IF groups 1130-1, . . . , 1130-K herein.

Although not illustrated in FIG. 11, there may be many logical group levels. Additionally, the logical group processors 1104 within the logical group levels may also be grouped logically, say, according to the table from which a reference to the logical group processors 1104 is found or according to the physical processor that performs the processing for each of the logical processors in the group

The virtual routers 1102 and the logical group processors 1104 may be considered to be embodied as individual processors in a network of processors within the PE router 1100. However, rather than individual processors, many virtual routers 1102 and logical group processors 1104 may be implemented as logical processors employing the processing power of a single physical processor.

A VRF administration unit 1108 is considered to be connected to each of the virtual routers 1102 and the logical group processors 1104 for distribution of the tables necessary for the operation of the virtual routers 1102 and the logical group processors 1104. In the interest of clarity, these connections are not shown in FIG. 11.

In overview, the architecture illustrated in FIG. 11 allows for multiple stages of logical group processing and a distribution of processing effort over a number of processors. In one instance, the multiple stages of logical group processing allow for the selection of VPN tunnels having different Quality of Service (QoS) parameters at an increasingly fine degree of granularity. As the logical group to associate with an incoming packet is inconsistent from packet to packet, the virtual routers 1102 are required to determine a route to the logical group processor 1104 necessary to apply a selected VRF to each received packet.

In operation, a virtual router 1102 receives a packet and may select, for instance, based on a logical group ID table, a logical group to associate with the packet. The virtual router 1102 may then determine an internal intermediate route to the logical group processor 1104 associated with the selected logical group. The virtual router 1102 may then transmit the packet, over the determined internal intermediate route, to the logical group processor 1104. At the logical group processor 1104, the VRF may be applied to the packet to determine a VPN tunnel on which to transmit the packet. As discussed hereinbefore, such determining may take the form of determining a BGP next hop, an IGP next hop and a label for the BGP next hop at the IGP next hop. Further, the logical group processor 1104 may also select an interface, among the interfaces of the PE router 1100, to which to transmit the packet in order that the packet is transmitted over the VPN tunnel to the IGP next hop. The logical group processor 1104 may then transmit the packet to the selected interface.

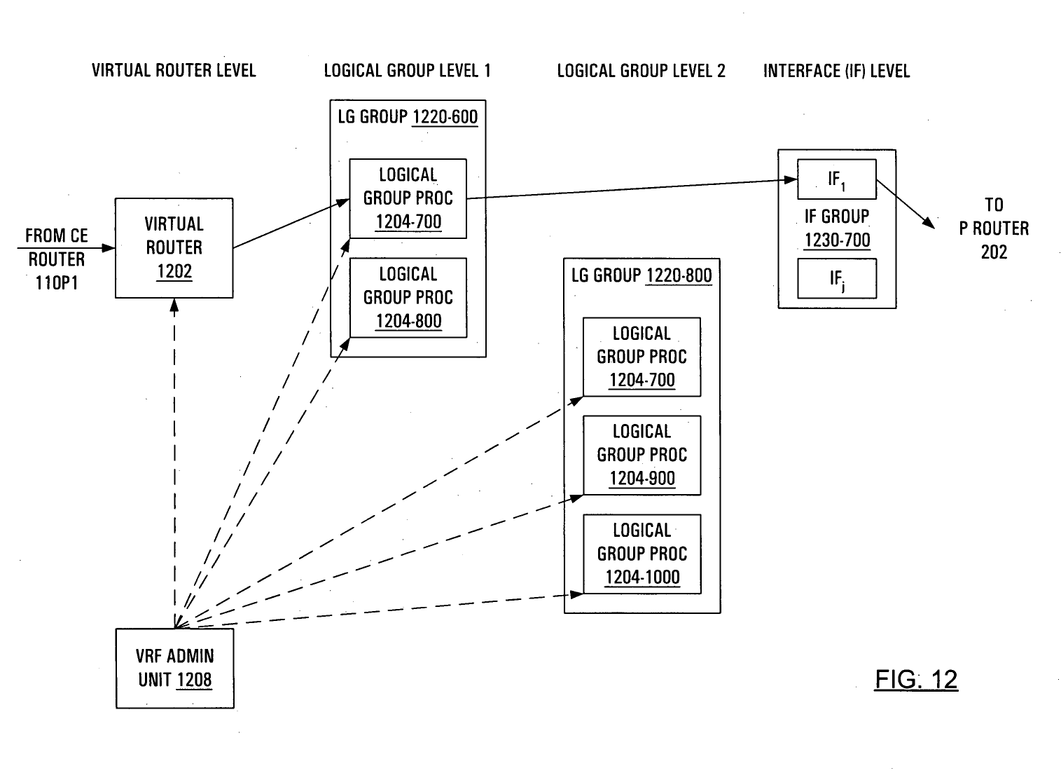

Application of the routing principles discussed above to one of the examples discussed hereinbefore is illustrated in FIG. 12.

Initially, a VRF administration unit 1208 may distribute the logical group ID table 600 to a virtual router 1202, the VRF for the logical grouping with the logical group ID of 700 to a logical group processor 1204-700, the VRF for the logical grouping with the logical group ID of 800 to a logical group processor 1204-800, the VRF for the logical grouping with the logical group ID of 900 to a logical group processor 1204-900 and the VRF for the logical grouping with the logical group ID of 1000 to a logical group processor 1204-1000. In addition to distributing the logical group ID table 600 and the VRFs for the logical groupings, the VRF administration unit 1208 may distribute an indication of an association of the logical grouping IDs with the logical group processors 1204.

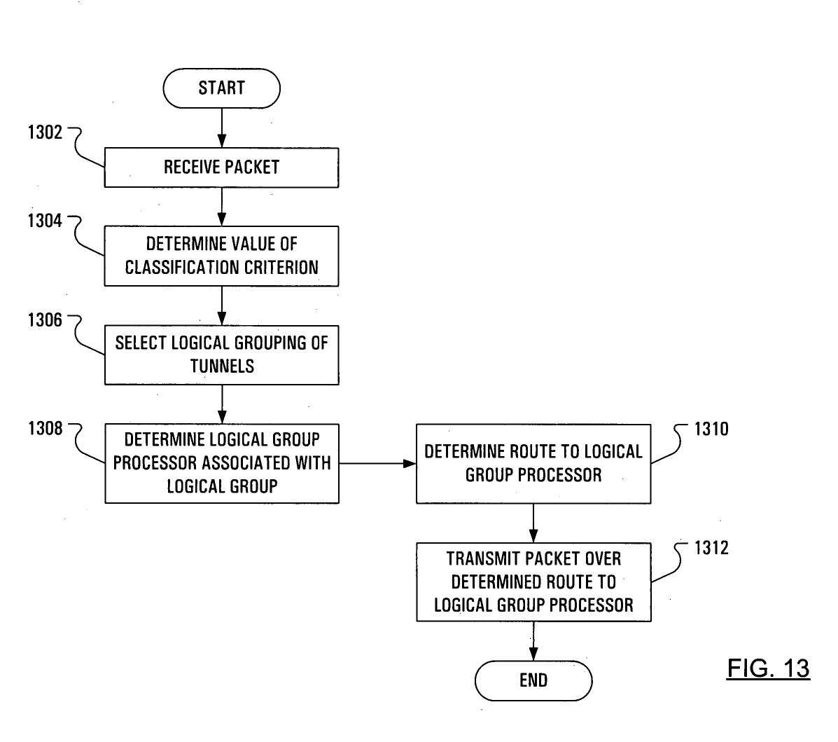

FIG. 13 illustrates steps of a method undertaken at the virtual router 1202 upon arrival of a packet. The virtual router 1202 may first receive the packet (step 1302) an subsequently determine a value of one or more classification criteria for the packet (step 1304), based on the classification criteria used in the logical group ID table 600. The value of the classification criteria may then be used to select (step 1306), based on the logical group ID table 600, a logical grouping of VPN tunnels to associate with the packet. In the previously presented example, those packets whose source IP address is 10.10.1.7 are associated with the logical grouping that has a logical group ID of 700. Once the logical grouping is associated with the packet, the virtual router 1202 may then determine an identity of a logical group processor associated with the selected logical grouping (step 1308). Continuing the previously presented example, the logical group processor 1204-700 may be identified as being associated with the logical grouping that has a logical group ID of 700. Based on the determined identity, the virtual router 1202 may determine a route (step 1310) to the logical group processor 1204-700. The virtual router 1202 may then transmit the packet, over the determined route, to the logical group processor 1204-700 (step 1312).

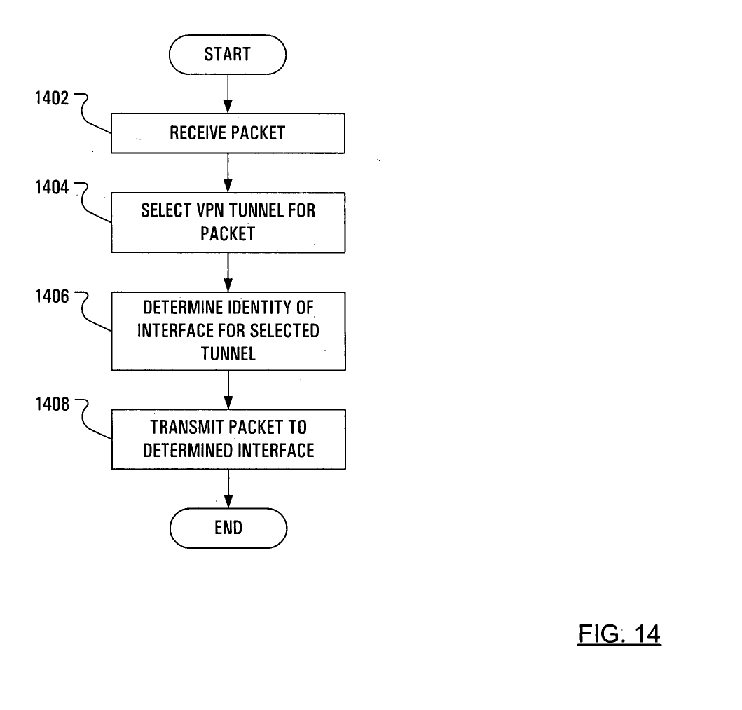

FIG. 14 illustrates steps of a method undertaken at the logical group. processor 1204-700 upon arrival of the packet from the virtual router 1202. The logical group processor 1204-700 initially receives the packet (step 1402). The logical group 700 VRF 701 (see FIG. 7) at the logical group processor 1204-700 may, for instance, associate a destination IP address identified in the packet with a label that may be used by the BGP next hop (i.e., at the second PE router 104B) to identify a network element having the destination IP address. The logical group processor 1204-700 may then select a VPN tunnel for the packet (step 1404). The selection of a VPN tunnel may involve use of identity of the BGP next hop as a key to lookup, in a logical group 700 IGP routing table 702 (see FIG. 7), an IGP route to the BGP next hop. The logical group 700 IGP routing table 702 may provide the logical group processor 1204-700 with an identity for an IGP next hop. From the same table, the logical group processor 1204-700 may learn the label assigned to the address of the BGP next hop (the second PE router 104B) by the IGP next hop according to an associated label switched path. With the IGP next hop identified, the logical group processor 1204-700 may determine the identity of an interface (e.g., IF₁) (step 1406) from an interface group 1230-700 and transmit the packet to the interface with the determined identity (step 1408).

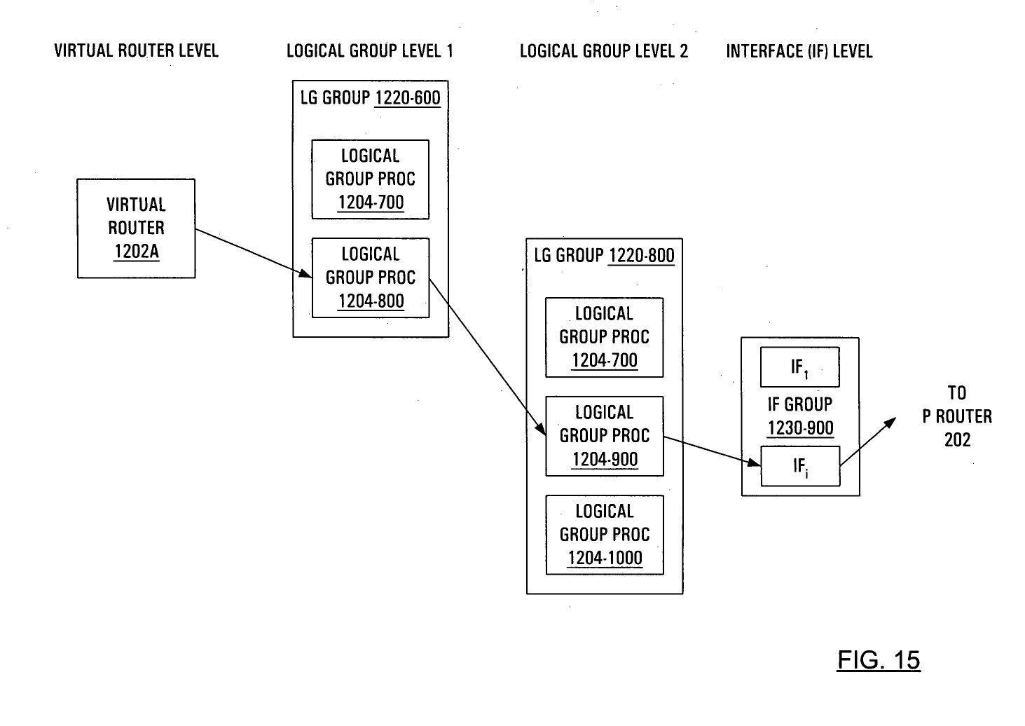

Application of the routing principles discussed above to another one of the examples discussed hereinbefore is illustrated in FIG. 15.

Upon arrival of a packet at the virtual router 1202, the virtual router 1202 may determine a value of one or more classification criteria for the packet, based on the classification criteria used in the logical group ID table 600. The value of the classification criteria may then be used to select, based on the logical group ID table 600, a logical grouping of VPN tunnels to associate with the packet. In the previously presented example, those packets whose traffic type is HTTP are associated with the logical grouping that has a logical group ID of 800. Once the logical grouping is associated with the packet, the virtual router 1202 may determine an identity of a logical group processor associated with the selected logical grouping. Continuing the previously presented example, the logical group processor 1204-800 may be identified as being associated with the logical grouping that has a logical group ID of 800. Based on the determined identity, the virtual router 1202 may determine an internal intermediate route to the logical group processor 1204-800. The virtual router 1202 may then transmit the packet, over the determined internal intermediate route, to the logical group processor 1204-800.

At the logical group processor 1204-800, the sub-logical group ID table 801 (see FIG. 8) associates a classification criteria of “cost” with a logical group ID. In FIG. 8, it may be seen that gold traffic is to be associated with the logical grouping that has the logical group ID of 900. The virtual router 1202, upon receiving a packet marked as gold, may associate the logical grouping that has the logical group ID of 900 with the packet. Once the logical grouping is associated with the packet, the logical group processor 1204-800 may then determine an identity of a logical group processor associated with the selected logical grouping. Continuing the previously presented example, the logical group processor 1204-900 may be identified as being associated with the logical grouping that has a logical group ID of 900. Based on the determined identity, the logical group processor 1204-800 may determine an internal intermediate route to the logical group processor 1204-900. The logical group processor 1204-800 may then transmit the packet, over the determined internal intermediate route, to the-logical group processor 1204-900.

At the logical group processor 1204-900, the logical group 900 VRF 901 (see FIG. 9) associates destination IP addresses with labels that are used by the BGP next hop to identify the same network elements. The logical group processor 1204-900 may then use the BGP next hop as a key to lookup, in a logical group 900 IGP routing table 902, an IGP route to the BGP next hop. The logical group 900 IGP routing table 902 may provide the logical group processor 1204-900 with an identity for an IGP next hop. From the same table, the logical group processor 1204-900 may learn the label assigned to the address of the BGP next hop (the second PE router 104B) by the IGP next hop according to an associated label switched path. As shown in FIG. 9, the logical group 900 IGP routing table 902 provides only one choice of IGP next hop. The single choice corresponds to the VPN tunnel referenced as VPNT2. With the IGP next hop identified, the logical group processor 1204-900 may select an interface (e.g., IFᵢ) from an interface group 1230-900 to which to transmit the packet.

Notably, the steps carried out at the logical group processor 1204-800 in the example presented in FIG. 15 map more closely to the steps carried out at the virtual router 1202 that to the steps carried out at the logical group processor 1204-900.

Notably, the examples presented hereinbefore illustrate that multiple logical group layers may be implemented. Further, logical group processors may be grouped. In FIGS. 12 and 15, the logical group processors 1204-700, 1204-800 that are associated with the logical groups having IDs that are referenced in the logical group ID table 600 are grouped as a logical grouping group 1220-600 and the logical group processors 1204-700, 1204-900, 1204-1000 that are associated with the logical groups having IDs that are reference in the sub-logical group ID table 801 are grouped as a logical grouping group 1220-800. Notably, the layers illustrated in FIGS. 11, 12 and 15 and the logical grouping groups 1220-600, 1220-800 are logical representations and do not necessarily refer to a physical location for the processors that implement the virtual routing and logical group processing tasks. Exemplary of this logical framework is the inclusion of the logical group processor 1204-700 as a member of both the logical grouping group 1220-600 in the logical group level 1 and the logical grouping group 1220-800 in the logical group level 2.

The role of the packet distribution unit 1101 (FIG. 11) may be to perform an algorithm to promote load balancing among the plurality of virtual routers 1102. Additionally, or alternatively, redundant virtual routers may be configured so that in the event of a failure on an original virtual router, the traffic destined for that virtual router may be “hot swapped” to a redundant virtual router having capabilities equivalent to those of the failed virtual router. Further, a service provider may configure each virtual router 1102 to relate to a particular customer accessing the backbone network 102 (FIG. 1).

As has been stated, the logical grouping of VPN tunnels provides for the distribution, by the VRF administration unit 1108, of many small VRFs rather than a single large VRF. In the event of a link failure, and the resulting inoperability of a VPN tunnel, potentially only a single small table needs to be redistributed, rather than the entire large table. Consequently, a reduction in network management overhead traffic may be realized. Additionally, there may be a reduction in effort expended by a system administrator responsible for supplying the VRFs to the VRF administration unit 1108. Along with the distribution of VRFs, one or more selection algorithms may also be distributed by the VRF administration unit 1108 to the virtual routers and logical group processors.

The distribution of updated VRFs responsive to a link failure may be considered “dynamic” VRF updating.

Rather than sending a policy, the PE router 1100 may have a database of policies 1103 and the distributor of VRFs (for instance, the VRF administration unit 1208) may simply transmit a reference to a policy in the policy database to be used in conjunction with a particular distributed VRF.

Although it may not be clear from the foregoing examples, it should be apparent to a person skilled in the art that the formation of logical groupings of VPN tunnels provides an opportunity to greatly simplify routing tables. Rather that a single large routing table covering all possible configurations of packets and VPN tunnels, a cascade of relatively small logical group ID tables may appropriately select a VPN tunnel for a given packet.

Additionally, as will be apparent to a person skilled in the art, much of the mechanics of a packet moving through a PE router is expected to occur as is typical. Such aspects as forwarding a packet from an input line card to an output line card over a particular route through a switching fabric and maintaining packet order are well known.

Advantageously, aspects of the present invention take full advantage of the characteristics that are used by VRFs to forward packets based on MPLS LSPs. Further advantageously, the size of VRFs may be reduced while providing flexibility in managing VPNs and scalability in terms of the size and granularity of the forwarding routing tables.

As will be apparent to a person skilled in the art the hereinbefore described method may be equally applicable to Point-to-Point network applications and to Multi-cast network applications. That is, a given virtual private network tunnel that may be logically grouped and individually selected, may have a single end point or multiple end points.

Other modifications will be apparent to those skilled in the art and, therefore, the invention is defined in the claims.

1. A method of handing a protocol data unit at a service provider edge router in a service provider network, said method comprising:
receiving a protocol data unit;
determining a value of a classification criterion for said protocol data unit;
selecting, based on said value of said classification criterion, a logical grouping of one or more virtual private network tunnels through said service provider network;
determining an identity of a processor associated with said logical grouping;
determining an internal route to said processor associated with said logical grouping; and
transmitting said protocol data unit, over said internal route, to said processor associated with said logical grouping.

2. The method of claim 1 further comprising, at said processor associated with said logical grouping:
receiving a protocol data unit;
selecting a candidate virtual private network tunnel, from among said one or more virtual private network tunnels in said logical grouping, on which to transmit said protocol data unit;
determining an identity of a particular interface among said plurality of interfaces, where said particular interface is associated a first destination router in said candidate virtual private network tunnel; and
transmitting said protocol data unit to said particular interface.

3. The method of claim 2 wherein said selecting said candidate virtual private network tunnel comprises:
determining a value of a classification criterion for said protocol data unit;
selecting a final destination router based on an association between said final destination router and said value of said classification criterion in a first table and
selecting said first destination router based on an association between said first destination router and said final destination router in a second table.

4. The method of claim 3 wherein said final destination router is a border gateway protocol next hop and said first destination router is an interior gateway protocol next hop.

5. The method of claim 4 wherein said candidate virtual private network tunnel is a label switched path and said selecting said virtual private network tunnel comprises:
determining a first label for use at said border gateway protocol next hop; and
determining a second label for use at said interior gateway protocol next hop.

6. A provider edge router in a service provider network operable to:
receive a protocol data unit;
determine a value of a classification criterion for said protocol data unit;
select, based on said value of said classification criterion, a logical grouping of one or more virtual private network tunnels through said service provider network;
determine an identity of a processor associated with said logical grouping;
determine a route to said processor associated with said logical grouping; and
transmit said protocol data unit, over said internal route, to said processor associated with said logical grouping.

7. A computer readable medium containing computer-executable instructions which, when performed by processor in a provider edge router in a service provider network, cause the processor to:
receive a protocol data unit;
determine a value of a classification criterion for said protocol data unit;
select, based on said value of said classification criterion, a logical grouping of one or more virtual private network tunnels through said service provider network;
determine an identity of a processor associated with said logical grouping;
determine a route to said processor associated with said logical grouping; and
transmit said protocol data unit, over said internal route, to said processor associated with said logical grouping.

8. A provider edge router in a service provider network, where virtual private network tunnels through said service provider network have been grouped in a plurality of logical groupings, said edge router comprising:
a plurality of logical grouping processors, each logical grouping processor of said plurality of logical grouping processor associated with at least one logical grouping of said plurality of logical groupings;
a plurality of virtual routers, each virtual router of said plurality of virtual routers operable to:
receive a protocol data unit;
determine a value of a classification criterion for said protocol data unit;
select, based on said value of said classification criterion, a candidate logical grouping from among said plurality of logical groupings;
determine an identity of a candidate logical grouping processor, from among said plurality of logical grouping processors, where said candidate logical grouping processor is associated with said candidate logical grouping;
determine an internal route to said candidate logical grouping processor; and
transmit said protocol data unit, over said internal route, to said candidate logical grouping processor.

9. The provider edge router of claim 8 further comprising a protocol data unit distribution unit operable to:
receive an ingress protocol data unit for said provider edge router;
select a candidate virtual router from among said plurality of virtual routers to which to transmit said ingress protocol data unit; and
transmit said ingress protocol data unit to said candidate virtual router.

10. The provider edge router of claim 9 wherein said protocol data unit distribution unit is further operable to select said candidate virtual router so as to evenly distribute protocol data unit load among said plurality of virtual routers.

11. The provider edge router of claim 9 wherein said protocol data unit distribution unit is further operable to:
receive an indication of an identity of a failed virtual router among said plurality of virtual routers; and
select a redundant virtual router in place of said failed virtual router.

12. The provider edge router of claim 9 wherein said protocol data unit distribution unit is further operable to:
receive an indication of an identity of a customer for said ingress protocol data unit; and
select said candidate virtual router based on said identity of said customer.

13. The provider edge router of claim 8 further comprising a table administration unit operable to transmit a table to said plurality of virtual routers, where, in said table, said identity of said candidate logical grouping processor is associated with said logical grouping.

14. The provider edge router of claim 8 further comprising:
a policy database configured to store:
a table in which said identity of said candidate logical grouping processor is associated with said logical grouping; and
a reference to said table;
a table administration unit operable to transmit, to said plurality of virtual routers, an indication of said reference to said table.
